(19) United States
(12) Patent Application Publication
(10) Pub. No.: US 2025/0299858 A1
(43) Pub. Date: Sep. 25, 2025

(54) MULTILAYER COIL COMPONENT

(71) Applicant: TDK Corporation, Tokyo (JP)

(72) Inventors: Yuto SHIGA, Tokyo (JP); So Kobayashi, Tokyo (JP); Teru Ishimori, Tokyo (JP); Yuichi Takubo, Tokyo (JP); Toru Yaginuma, Tokyo (JP)

(73) Assignee: TDK Corporation, Tokyo (JP)

(21) Appl. No.: 19/079,085

(22) Filed: Mar. 13, 2025

(30) Foreign Application Priority Data
Mar. 22, 2024 (JP) 2024-046966

(51) Int. Cl. H01F 5/04; H01F 27/29

(52) U.S. Cl. CPC H01F 5/04; H01F 27/292

(57) ABSTRACT

A multilayer coil component includes an element body, a coil in the element body, and an external electrode exposed on the element body. The coil has a plurality of coil conductors each having a thickness and a path length. The external electrode is electrically connected to the coil. The plurality of coil conductors includes at least one first coil conductor and at least one second coil conductor. The at least one second coil conductor has a path length longer than the path length of the at least one first coil conductor and has a thickness larger than the thickness of the at least one first coil conductor.

### CROSS-REFERENCE TO RELATED APPLICATIONS

This application is based upon and claims the benefit of priority from Japanese Patent Application No. 2024-046966, filed On Mar. 22, 2024, the entire contents of which are incorporated herein by reference.

### BACKGROUND

### Field

The present disclosure relates to a multilayer coil component.

### Description of the Related Art

A multilayer coil component including an element body and a coil in the element body is known (for example, Japanese Unexamined Patent Publication No. 2018-113309). The coil includes a plurality of coil conductors electrically connected to each other.

### SUMMARY

An object of one aspect of the present disclosure is to provide a multilayer coil component capable of improving a quality factor (hereinafter, referred to as Q Factor).

The multilayer coil component according to one aspect of the present disclosure includes an element body, a coil in the element body, and an external electrode on the element body. The coil includes a plurality of coil conductors each having a thickness and a path length. The external electrode is electrically connected to the coil. The plurality of coil conductors includes a first coil conductor and a second coil conductor. The second coil conductor has a path length longer than the path length of the first coil conductor and has a thickness larger than the thickness of the first coil conductor.

The Q factor of the multilayer coil component is proportional to a reciprocal of electric resistance. The electric resistance of the coil having the plurality of coil conductors depends on the combined resistance of the coil conductors in the plurality of coil conductors. Since the electric resistance of a conductor is proportional to a length of the conductor and inversely proportional to a cross-sectional area of the conductor, electric resistance of each coil conductor in the plurality of coil conductors varies based on a path length of the coil conductor and a thickness of the coil conductor. Therefore, the Q factor of the multilayer coil component depends on the path length and thickness of each of the plurality of coil conductors include in the coil.

In the multilayer coil component, a plurality of inductance values are required for the predetermined outer shape size. Since the inductance value depends on the number of turns of the coil, a path length of each of the plurality of coil conductors constituting the coil is tends not to be a constant value. In a configuration where the respective thicknesses of the plurality of coil conductors are equal to each other, a coil conductor having a longer path length than another coil conductor has an electric resistance larger than an electric resistance of the other coil conductors.

According to one aspect described above, the second coil conductor has the path length longer than the path length of the first coil conductor and has the thickness larger than the thickness of the first coil conductor. The combined resistance of the first coil conductor and the second coil conductor in one aspect described above is smaller than the combined resistance in a configuration in which the second coil conductor has a path length longer than the path length of the first coil conductor, and the second coil conductor has a thickness equal to or less than the thickness of the first coil conductor. Since the electric resistance of the coil according to one aspect described above is smaller than the electric resistance of the coil having the configuration in which the second coil conductor has the path length longer than the path length of the first coil conductor and the second coil conductor has the thickness smaller than the thickness of the first coil conductor. Therefore, the aspect described above can improve the Q factor of the multilayer coil component.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer coil component according to an embodiment;

FIG. 2 is a perspective view of a coil according to the present embodiment;

FIG. 3 is a plan view of the coil according to the present embodiment as viewed from a side surface;

FIG. 4 is a plan view of the coil according to the present embodiment as viewed from a main surface;

FIG. 5 is an exploded view illustrating a configuration of the multilayer coil component according to the present embodiment;

FIG. 6 is a perspective view of a coil according to a modification of the present embodiment;

FIG. 7 is a plan view of the coil according to the modification of the present embodiment as viewed from a side surface;

FIG. 8 is a plan view of the coil according to the modification of the present embodiment as viewed from a main surface;

FIG. 9 is an exploded view illustrating a configuration of a multilayer coil component according to the modification of the present embodiment; and

FIG. 10 is an exploded view illustrating a configuration of a multilayer coil component according to another modification of the present embodiment.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

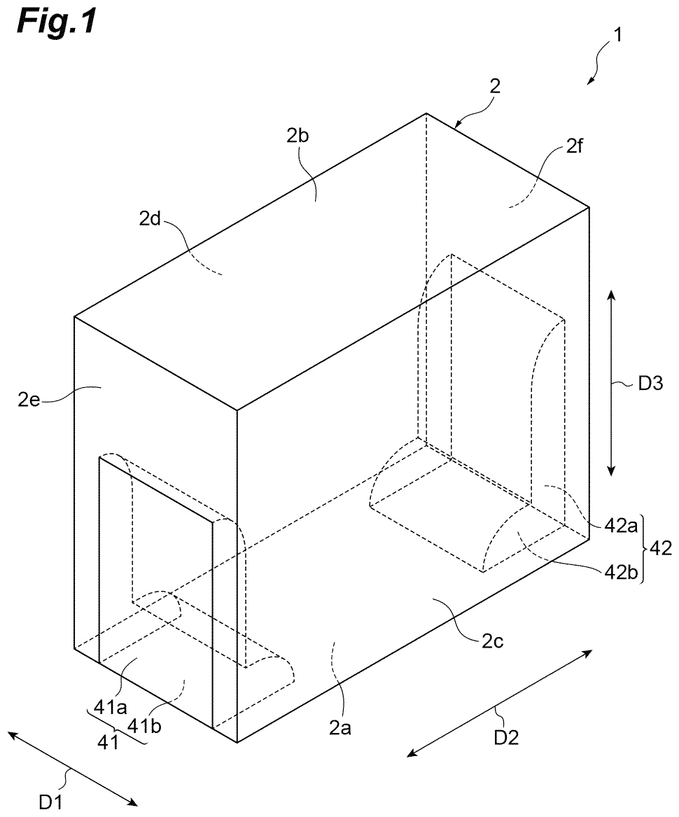

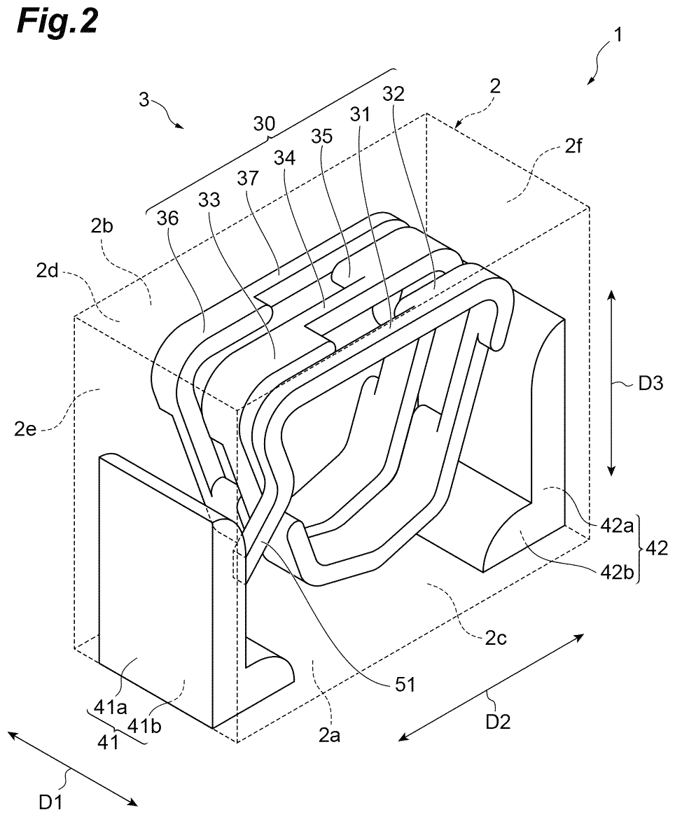

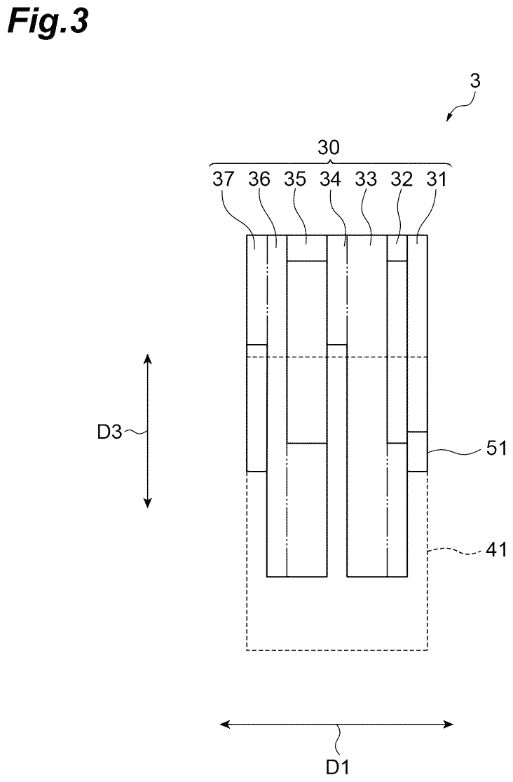

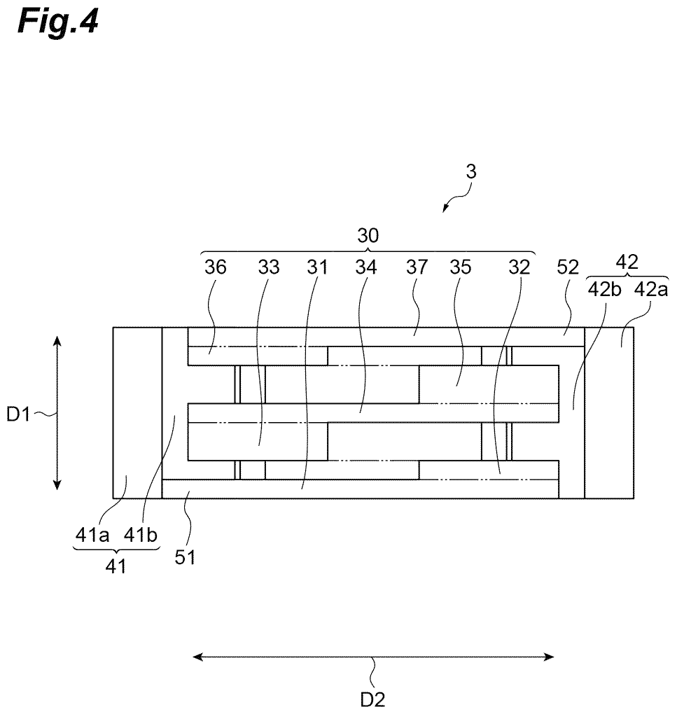

With reference to FIGS. 1 to 4, a configuration of a multilayer coil component 1 according to the present embodiment will be described. FIG. 1 is the perspective view of the multilayer coil component according to the present embodiment. FIG. 2 is the perspective view of the coil according to the present embodiment. FIG. 3 is the plan view of the coil according to the present embodiment as viewed from a side surface 2e illustrated in FIG. 1. FIG. 4 is the plan view of the coil according to the present embodiment as viewed from a main surface 2b illustrated in FIG. 1. The multilayer coil component 1 according to the present embodiment is solder-mounted to an electronic device. The electronic device includes, for example, a circuit board or an electronic component.

As illustrated in FIGS. 1 and 2, the multilayer coil component 1 includes an element body 2, a coil 3 in the element body 2, a pair of external electrodes 41 and 42 on surfaces of the element body 2, and a pair of connection conductors 51 and 52 in the element body 2. The external electrodes 41 and 42 are electrically connected to the coil 3. The element body 2 has a rectangular parallelepiped shape. The rectangular parallelepiped shape includes a rectangular parallelepiped shape in which corner and ridge are chamfered, or a rectangular parallelepiped shape in which corner parts and ridge line parts are rounded.

The element body 2 includes a pair of main surfaces 2a and 2b, a pair of side surfaces 2c and 2d, and a pair of side surfaces 2e and 2f. The pair of main surfaces 2a and 2b oppose each other. The pair of side surfaces 2c and 2d oppose each other. The pair of side surfaces 2e and 2f oppose each other. The main surfaces 2a and 2b, the side surfaces 2c and 2d, and the side surfaces 2e and 2f have rectangular shapes. The main surfaces 2a and 2b are adjacent to the side surfaces 2c and 2d and the side surfaces 2e and 2f. The side surfaces 2c and 2d are each adjacent to the side surfaces 2e and 2f. When the multilayer coil component 1 is solder-mounted on the electronic device, the main surface 2a faces the electronic device to be solder-mounted. The main surfaces 2a and 2b, the side surfaces 2c and 2d, and the side surfaces 2e and 2f are flat surfaces. The flat surface means a surface formed so as to be a flat surface and is not limited to a geometrically complete flat surface. The flat surface may include curvature and unevenness that occur in a manufacturing process.

A direction D3 in which the pair of main surfaces 2a and 2b oppose each other is orthogonal to each of the main surfaces 2a and 2b. A direction D1 in which the pair of side surfaces 2c and 2d oppose each other is orthogonal to each of the side surfaces 2c and 2d. A direction D2 in which the pair of side surfaces 2e and 2f oppose each other is orthogonal to each of the side surfaces 2e and 2f. The direction D3 is orthogonal to the direction D1 and the direction D2. The direction D1 and the direction D2 are orthogonal to each other. A pair of recesses corresponding to the pair of external electrodes 41 and 42 is formed in the element body 2.

The external electrodes 41 and 42 have L-shaped cross sections when viewed from the direction D1. The recesses corresponding to the external electrodes 41 and 42 formed in the element body 2 have L shapes when viewed from the direction D1. The external electrode 41 includes a portion 41a and a portion 41b. A surface of the portion 41a is oriented in the same orientation as the side surface 2e, and a surface of the portion 41b is oriented in the same orientation as the main surface 2a. The portion 41a and the portion 41b are continuous along a ridge portion between the side surface 2e and the main surface 2a. The external electrode 42 includes a portion 42a and a portion 42b. A surface of the portion 42a is oriented in the same orientation as the side surface 2f, and a surface of the portion 42b is oriented in the same orientation as the main surface 2a. The portion 42a and the portion 42b are continuous along a ridge portion between the side surface 2f and the main surface 2a.

In the present embodiment, lengths of the external electrodes 41 and 42 in the direction D3 are longer than lengths of the external electrodes 41 and 42 in the direction D2. The portions 41b and 42b are disposed to be exposed in the same orientation as the main surface 2a. Surfaces of the portions 41b and 42b and the main surface 2a may be located on the same flat surface. The surfaces of the portions 41b and 42b may protrude from the main surface 2a. The portion 41a is disposed to be exposed in the same orientation as the side surface 2e. The surface of the portion 41a and the side surface 2e may be located on the same flat surface. The surface of the portion 41a may protrude from the side surface 2e. The portion 42a is disposed on the side surface 2f to be exposed in the same orientation as the side surface 2f. The surface of the portion 42a and the side surface 2f may be located on the same surface. The surface of the portion 42a may protrude from the side surface 2f. In the present embodiment, lengths of the portions 41a and 42a in the direction D3 are longer than lengths of the portions 41b and 42b in the direction D2.

As illustrated in FIGS. 2 to 4, the coil 3 includes a plurality of coil conductors 30. The plurality of coil conductors 30 are electrically connected to each other. The plurality of coil conductors 30 includes coil conductors 31, 32, 33, 34, 35, 36 and 37. The coil conductors 31, 34, and 37 are defined as, for example, first coil conductors, and the coil conductors 33 and 35 are defined as, for example, second coil conductors. The coil conductors 31 to 37 are arranged in this order (the coil conductor 31, the coil conductor 32, the coil conductor 33, the coil conductor 34, the coil conductor 35, the coil conductor 36, the coil conductor 37) along the direction D1 and are adjacent to each other. The coil conductor 31 is an endmost coil conductor including one end of the coil 3 in the direction D1. The coil conductor 37 is an endmost coil conductor including the other end of the coil 3 in the direction D1. The coil 3 includes seven coil conductors 31 to 37 coupled in the direction D1. The number of turns of the coil 3 is 2.5. Each of the coil conductors 31 to 37 constitutes a part of an annular track in the coil 3. Each of the coil conductors 31 to 37 has, for example, a shape in which a part of a loop is interrupted. The plurality of coil conductors 30 each has a path length and a thickness.

The respective coil conductors 31 to 37 includes a first end and a second end. The first end corresponds to one end in the shape in which the part of the loop is interrupted. The second end corresponds to the other end in the shape in which the part of the loop is interrupted. The respective coil conductors 31 to 37 extends along paths from the first ends to the second ends in respective layers of the coil conductors 31 to 37. Lengths of the paths from the first ends to the second ends of the coil conductors 31 to 37 are referred to as path lengths of the respective coil conductors 31 to 37. The path length may be the minimum length from an end surface of a first end to an end surface of a second end of the respective coil conductors 31 to 37. For example, the path length may be an inner circumference from the first end surface to the second end surface of the respective coil conductor 31 to 37. Each layer of the coil conductors 31 to 37 corresponds to each layer constituting the multilayer coil component 1. Each layer of the coil conductors 31 to 37 extends along a flat surface intersecting the direction D1 in which the coil conductors 31 to 37 are arranged. In the present embodiment, each layer of the coil conductors 31 to 37 extends along the direction D2 and the direction D3.

Widths of the respective coil conductors 31 to 37 in a direction orthogonal to paths of the respective coil conductors 31 to 37 are equal to each other. In the present specification, the term “equal” does not necessarily mean that values coincide with each other. Even in a case where values include slight differences, manufacturing errors, or measurement errors within a preset range, the values may be regarded as being equal to each other.

Thicknesses of the coil conductors 33 and 35 are equal to each other. In the present specification, the “thickness” of the coil conductor is a distance between one surface of the coil conductor in the direction D1 and the other surface located opposite to the one surface. The average distance between one surface and the other surface of the coil conductor in the direction D1 may be set as the thickness of the coil conductor. The thicknesses of the coil conductors 31, 32, 34, 36, and 37 are equal to each other. The coil conductors 33 and 35 have a thickness larger than the thickness of the coil conductors 31, 34, and 37. The coil conductors 33 and 35 have a thickness that is 1.25 times or more than the thickness of the coil conductors 31, 34, and 37. The coil conductors 33 and 35 may have a thickness that is twice or more than the thickness of the coil conductors 31, 34, and 37. The coil conductors 33 and 35 may have the largest thickness among the plurality of coil conductors 30. The coil conductors 31, 34, and 37 may have the smallest thickness among the plurality of coil conductors 30.

Ends of a pair of coil conductors adjacent to each other among the plurality of coil conductors 30 overlap each other and are coupled to each other. In the present embodiment, the ends of a pair of coil conductors adjacent to each other among the plurality of coil conductors 30 completely overlap each other. However, the ends may at least partially overlap each other. The coil conductors 31 and 32, the coil conductors 32 and 33, the coil conductors 33 and 34, the coil conductors 34 and 35, the coil conductors 35 and 36, and the coil conductors 36 and 37 are a pair of coil conductors adjacent to each other in the direction D1. For example, the second end of the coil conductor 31 and the first end of the coil conductor 32 overlap each other in the direction D1 and are coupled to each other. A pair of coil conductors adjacent to each other among the plurality of coil conductors 30 is directly and physically connected to each other at each end.

The connection conductor 51 connects the coil 3 and the external electrode 41. The coil 3 and the external electrode 41 are electrically and physically connected to each other via the connection conductor 51. The connection conductor 51 is continuous with the coil conductor 31 in the same layer as the coil conductor 31. The connection conductor 51 extends between the first end of the coil conductor 31 and the portion 41a of the external electrode 41. A thickness of the connection conductor 51 is equal to the thickness of the coil conductor 31. The connection conductor 52 connects the coil 3 and the external electrode 42 to each other. The coil 3 and the external electrode 42 are electrically and physically connected to each other via the connection conductor 52. The connection conductor 52 is continuous with the coil conductor 37 in the same layer as the coil conductor 37. The connection conductor 52 extends between the second end of the coil conductor 37 and the portion 42a of the external electrode 42. A thickness of the connection conductor 52 is equal to the thickness of the coil conductor 37. Respective thicknesses of the connection conductor 51 and the connection conductor 52 are equal to each other.

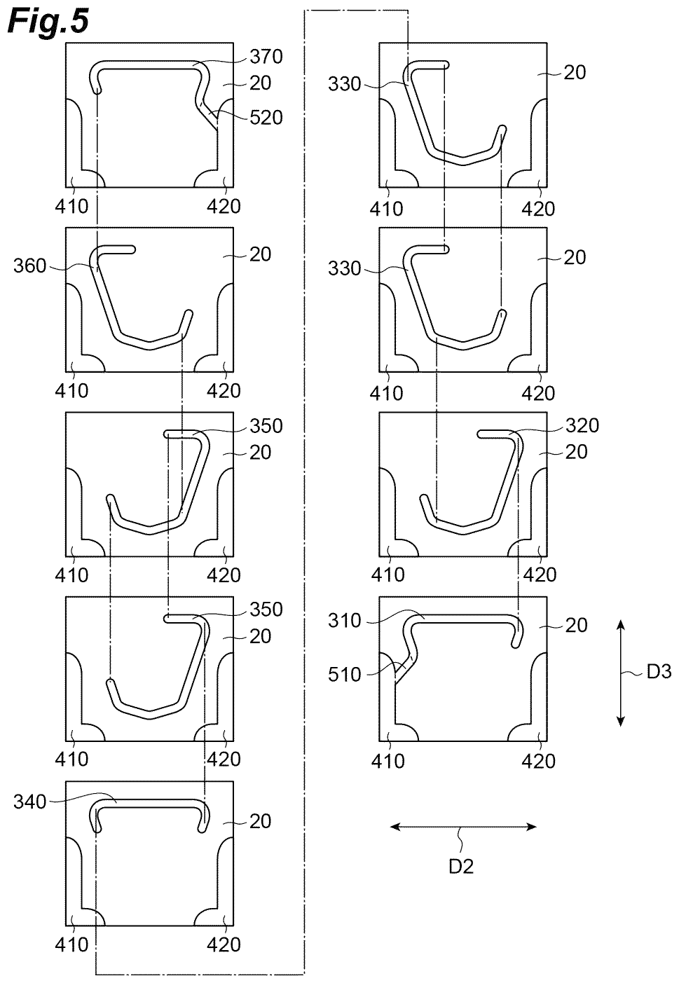

FIG. 5 is an exploded view illustrating a configuration of the multilayer coil component 1 according to the present embodiment. In the present embodiment, a lamination direction of the multilayer coil component 1 is along the direction D1. FIG. 5 illustrates a plurality of layers constituting the multilayer coil component 1 as viewed from the direction D1. The plurality of layers constituting the multilayer coil component 1 includes a layer constituting the element body 2, a layer constituting the coil 3, layers constituting the external electrodes 41 and 42, and layers constituting the connection conductors 51 and 52. Thicknesses of the plurality of layers are equal to each other. Hereinafter, with reference to FIG. 5, the element body 2, the plurality of coil conductors 30 of the coil 3, the external electrodes 41 and 42, and the connection conductors 51 and 52 will be described.

The element body 2 includes a plurality of laminated insulator layers 20. In the present embodiment, the number of the plurality of insulator layers 20 is “13”. FIG. 5 illustrates nine insulator layers 20 while two insulator layers 20 located at each end in the direction D1 are omitted. In the actual element body 2, the respective insulator layers 20 are integrated to such an extent that boundaries between the insulator layers 20 cannot be visually recognized. Each of the insulator layers 20 includes, for example, a nonmagnetic material. The nonmagnetic material includes, for example, a glass ceramic material or a dielectric material. In the present embodiment, each insulator layer 20 includes a sintered body of a green sheet including a nonmagnetic material. Each of the insulator layers 20 may include, for example, a magnetic material.

The external electrode 41 and the external electrode 42 include a plurality of laminated electrode layers 410 and a plurality of laminated electrode layers 420, respectively. In the present embodiment, the number of the plurality of electrode layers 410 and the number of the plurality of electrode layers 420 are each “9”. In the actual external electrode 41, the respective electrode layers 410 are integrated to such an extent that boundaries between the electrode layers 410 cannot be visually recognized. In the actual external electrode 42, the respective electrode layers 420 are integrated to such an extent that boundaries between the electrode layers 420 cannot be visually recognized. Each of the electrode layers 410 and 420 is provided in a defective portion formed in the corresponding insulator layers 20. A pair of recesses corresponding to the external electrodes 41 and 42 is obtained by the defective portions formed in the respective insulator layers 20. Each of the electrode layers 410 and 420 includes, for example, a conductive material. The conductive material includes, for example, Ag or Pd. In the present embodiment, each of the electrode layers 410 and 420 includes a sintered body of a conductive paste including powder of the conductive material.

The connection conductor 51 and the connection conductor 52 include an electrode layer 510 and an electrode layer 520, respectively. The electrode layer 510 is continuous with a coil conductor layer 310, and the electrode layer 520 is continuous with a coil conductor layer 370. Each of the electrode layers 510 and 520 is provided in a defective portion formed in the corresponding insulator layer 20. Each of the electrode layer 510 and 520 includes, for example, the same material as that of each of the electrode layers 410 and 420. Each of the electrode layers 510 and 520 includes, for example, a sintered body of a conductive paste.

The plurality of coil conductors 30 includes a plurality of coil conductor layers corresponding to each of the plurality of coil conductors 30. The coil conductor 31 includes the coil conductor layer 310. The coil conductor 32 includes a coil conductor layer 320. The coil conductor 33 includes a plurality of coil conductor layers 330 that entirely overlap each other. In the present embodiment, the number of the plurality of coil conductor layers 330 is “2”. The coil conductor 34 includes a coil conductor layer 340. The coil conductor 35 includes a plurality of coil conductor layers 350. In the present embodiment, the number of the plurality of coil conductor layers 350 that entirely overlap each other is “2”. The coil conductor 36 includes a coil conductor layer 360. The coil conductor 37 includes the coil conductor layer 370.

In each of the coil conductors 33 and 35 of the actual coil 3, each of the coil conductor layers 330 and 350 are integrated to such an extent that boundaries between the coil conductor layers 330 and 350 cannot be visually recognized. Each of the coil conductor layers 310 to 370 is provided in a defective portion formed in the corresponding insulator layer 20. Each of the coil conductor layers 310 to 370 includes, for example, the same material as that of each of the electrode layers 410 and 420. Each of the coil conductor layers 310 to 370 includes, for example, a sintered body of a conductive paste.

Hereinafter, with reference to FIGS. 2 and 5, the coil 3 and the plurality of coil conductors 30 will be described. The coil conductor layers 310 to 370 illustrated in FIG. 5 correspond to the coil conductors 31 to 37 viewed from the direction D1.

When viewed from the direction D1, the coil 3 has a pentagonal shape. The pentagon is line-symmetric in the direction D2 relative to a center line along the direction D3. The pentagon includes a first side located closest to the main surface 2b, a second side located closest to the side surface 2f, a third side and a fourth side located closest to the main surface 2a, and a fifth side located closest to the side surface 2e. The first side and the second side are connected at a first vertex, the second side and the third side are connected at a second vertex, the third side and the fourth side are connected at a third vertex, the fourth side and the fifth side are connected at a fourth vertex, and the fifth side and the first side are connected at a fifth vertex. With respect to a center line passing through the third vertex between the third side and the fourth side, the second side and the fifth side are line-symmetric with each other, and the third side and the fourth side are line-symmetric with each other. The first side is longer than each of the second side and the fifth side. Each of the second side and the fifth side is longer than each of the third side and the fourth side. When viewed from the direction D1, each path of the plurality of coil conductors 30 includes at least one of the first side to the fifth side.

The paths of the coil conductors 31, 34, and 37 include the first side. Path lengths of the coil conductors 31, 34, and 37 are each a ½ turn or less. The paths of the coil conductors 32 and 35 include the second side, the third side, and the fourth side. The paths of the coil conductors 33 and 36 include the third side, the fourth side, and the fifth side. Path lengths of the coil conductors 32, 33, 35 and 36 are each a ½ turn or more. Each of the coil conductors 33 and 35 have path lengths longer than the path lengths of the respective coil conductors 31, 34, and 37. The coil conductors 33 and 35 may have the longest path length among the plurality of coil conductors 30. The coil conductors 31, 34, and 37 may have the shortest path length among the plurality of coil conductors 30.

The path lengths of the coil conductors 31 and 37 are equal to each other. The path lengths of the coil conductors 32, 33, 35, and 36 are equal to each other. The coil conductors 33 and 35 have path lengths longer than the path lengths of the coil conductors 31, 34, and 37, respectively. The coil conductors 33 and 35 may have the longest path length among the plurality of coil conductors 30. The coil conductor 34 may have the shortest path length among the plurality of coil conductors 30.

As described above, in the multilayer coil component 1, the coil conductors 33 and 35 have a path length longer than the path length of the coil conductors 31, 34, and 37 and have a thickness larger than the thickness of the coil conductors 31, 34, and 37. Therefore, the electric resistance of the coil 3 is smaller than the electric resistance of the coil having a configuration in which the coil conductors 33 and 35 have a thickness equal to or less than the thickness of the coil conductors 31, 34, and 37. Therefore, the multilayer coil component 1 makes it possible to improve the Q factor of the multilayer coil component.

In the multilayer coil component 1, the coil conductors 33 and 35 have the longest path length among the plurality of coil conductors 30, and the coil conductors 31, 34, and 37 include the coil conductor 34 having the shortest path length among the plurality of coil conductors 30. The electric resistance of the coil 3 in the configuration in which the thickness of the coil conductors 33 and 35 having the longest path length is larger than the thickness of the coil conductor 34 having the shortest path length is still smaller. Therefore, the multilayer coil component 1 makes it possible to further improve the Q factor of the multilayer coil component.

In the multilayer coil component 1, ends of a pair of coil conductors adjacent to each other among the plurality of coil conductors 30 overlap each other and are coupled to each other.

In a coil in which ends of a pair of coil conductors adjacent to each other are indirectly connected to each other via another conductor, the other conductor may increase the combined resistance of the plurality of coil conductors 30. In the coil 3 in which ends of the pair of coil conductors adjacent to each other overlap each other and are coupled to each other, the ends of the pair of coil conductors adjacent to each other are directly connected to each other, and thus, the coil 3 does not include another conductor that may increase the combined resistance. Therefore, since the multilayer coil component 1 is directly connected so as not to include the other conductor, the decrease in the Q factor is further suppressed.

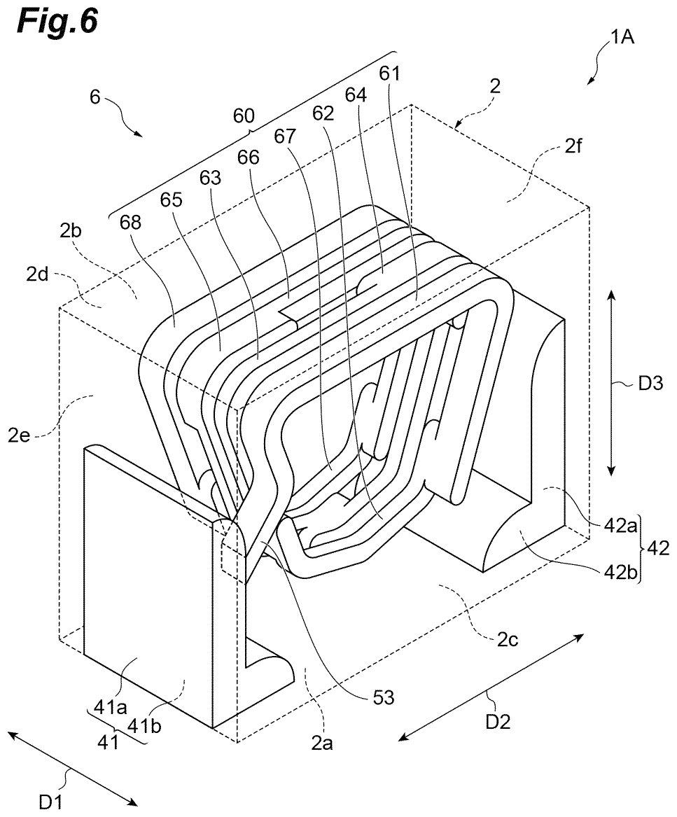

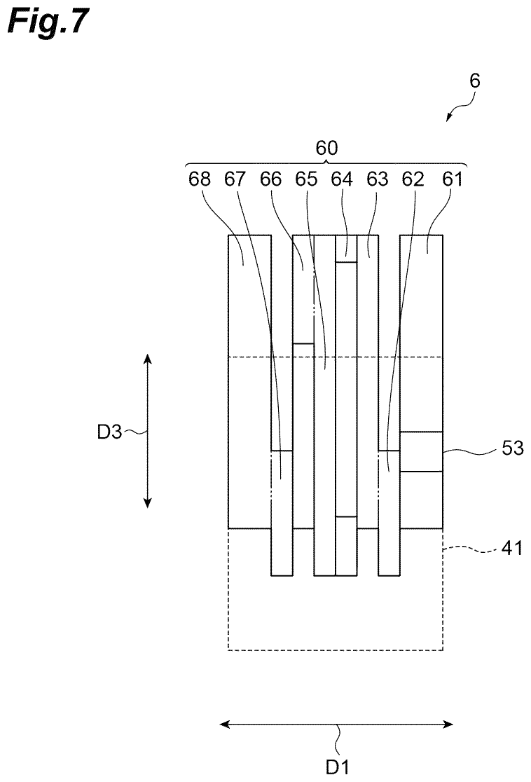

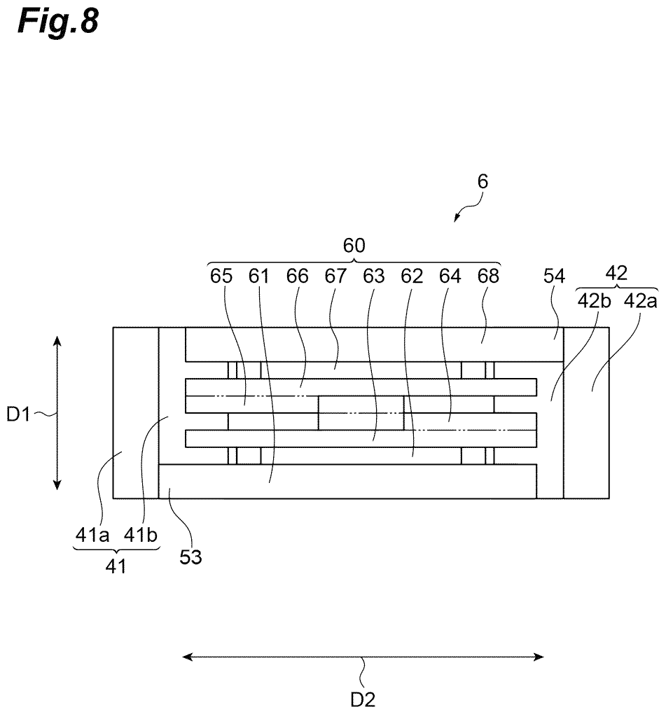

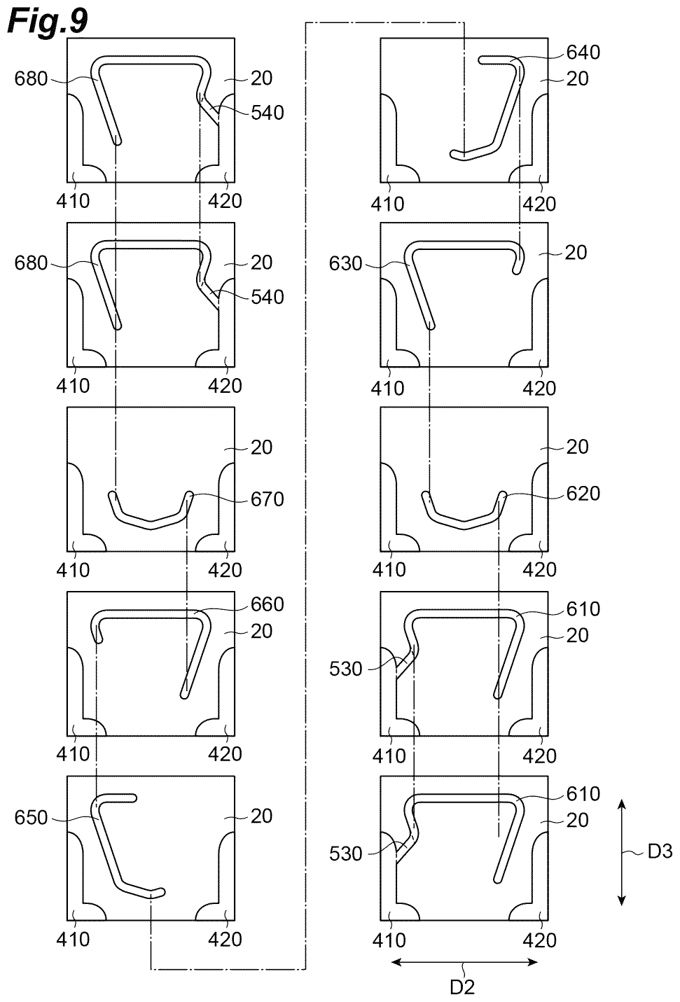

Next, with reference to FIGS. 6 to 9, a configuration of a multilayer coil component 1A according to a modification of the present embodiment will be described. The multilayer coil component 1A according to the modification includes a coil 6 and connection conductors 53 and 54 instead of the coil 3 and the connection conductors 51 and 52. FIG. 6 is a perspective view of a coil according to the modification. FIG. 7 is a plan view of the coil according to the modification as viewed from a side surface 2e. FIG. 8 is a plan view of the coil according to the modification as viewed from a main surface 2b. FIG. 9 is an exploded view illustrating a configuration of a multilayer coil component according to the modification. Hereinafter, differences between the embodiment described above and the present modification will be mainly described.

As illustrated in FIGS. 6 to 9, the coil 6 includes a plurality of coil conductors 60 connected to each other. The plurality of coil conductors 60 are electrically connected to each other. The plurality of coil conductors 60 includes coil conductors 61, 62, 63, 64, 65, 66, 67, and 68. The coil conductors 62 and 67 are defined as, for example, first coil conductors, and the coil conductors 61 and 68 are defined as, for example, second coil conductors. The coil conductors 61 to 68 are arranged in this order (the coil conductor 61, the coil conductor 62, the coil conductor 63, the coil conductor 64, the coil conductor 65, the coil conductor 66, the coil conductor 67, the coil conductor 68) along the direction D1. The coil conductor 61 is an endmost coil conductor including one end of the coil 6 in the direction D1. The coil conductor 68 is an endmost coil conductor including the other end of the coil 6 in the direction D1. The coil 6 includes eight coil conductors 61 to 68 coupled in the direction D1. The number of turns of the coil 6 is 3.5. The plurality of coil conductors 60 each has a path length and a thickness.

Thicknesses of the coil conductors 61 and 68 are equal to each other. The thicknesses of the coil conductors 62 to 67 are equal to each other. The coil conductors 61 and 68 have a thickness larger than the thickness of the coil conductors 62 and 67. The coil conductors 61 and 68 have a thickness that is 1.25 times or more than the thickness of the coil conductors 62 and 67. The coil conductors 61 and 68 may have a thickness equal to twice the thickness of the coil conductors 62 and 67. The coil conductors 61 and 68 may have the largest thickness among the plurality of coil conductors 60. The coil conductors 62 and 67 may have the smallest thickness among the plurality of coil conductors 60.

The connection conductor 53 connects the coil 6 and the external electrode 41. The coil 6 and the external electrode 41 are electrically and physically connected to each other via the connection conductor 53. The connection conductor 53 is continuous with the coil conductor 61 in the same layer as the coil conductor 61. The connection conductor 53 extends between the first end of the coil conductor 61 and the portion 41a of the external electrode 41. A thickness of the connection conductor 53 is equal to the thickness of the coil conductor 61. The connection conductor 54 connects the coil 6 and the external electrode 42 to each other. The coil 6 and the external electrode 42 are electrically and physically connected to each other via the connection conductor 54. The connection conductor 54 is continuous with the coil conductor 68 in the same layer as the coil conductor 68. The connection conductor 54 extends between the second end of the coil conductor 68 and the portion 42a of the external electrode 42. A thickness of the connection conductor 54 is equal to the thickness of the coil conductor 68. Respective thicknesses of the connection conductor 53 and the connection conductor 54 are equal to each other.

The connection conductor 53 includes a plurality of electrode layers 530 that entirely overlap each other. The connection conductor 54 includes a plurality of electrode layers 540 that entirely overlap each other. In the present modification, the number of the plurality of electrode layers 530 and the number of the plurality of electrode layers 540 are each “2”. The plurality of electrode layers 530 are continuous with the plurality of coil conductor layers 610, respectively. The plurality of electrode layers 540 are continuous with the plurality of coil conductor layers 680, respectively. In the actual connection conductor 53, the respective electrode layers 530 are integrated to such an extent that boundaries between the electrode layers 530 cannot be visually recognized. In the actual connection conductor 54, the respective electrode layers 540 are integrated to such an extent that boundaries between the electrode layers 540 cannot be visually recognized. The plurality of coil conductors 60 includes a plurality of coil

conductor layers corresponding to each of the plurality of coil conductors 60. The coil conductor 61 includes a plurality of coil conductor layers 610 that entirely overlap each other. In the present modification, the number of the plurality of coil conductor layers 610 is “2”. The coil conductors 62 to 67 include the coil conductor layers 620 to 670, respectively. The coil conductor 68 includes a plurality of coil conductor layers 680 that entirely overlap each other. In the present modification, the number of the plurality of coil conductor layers 680 is “2”.

Hereinafter, with reference to FIGS. 6 and 9, each of the coil 6 and the plurality of coil conductors 60 will be described. The coil conductor layers 610 to 680 illustrated in FIG. 9 correspond to the coil conductors 61 to 68 viewed from the direction D1. When viewed from the direction D1, the coil 6 has a pentagonal shape similarly to the coil 3. When viewed from the direction D1, each path of the plurality of coil conductors 60 includes at least one of the first side to the fifth side. The paths of the coil conductors 61 and 66 include the first side and the second side. The paths of the coil conductors 62 and 67 include the third side and the fourth side. The paths of the coil conductors 63 and 68 include the fifth side and the first side. The paths of the coil conductor 64 includes the second side and the third side. The paths of the coil conductor 65 includes the fourth side and the fifth side. The path lengths of the coil conductors 62 and 67 are equal to each other. The coil conductors 61 and 68 have path lengths longer than the path lengths of the coil conductors 62 and 67, respectively. The coil conductors 62 and 67 may have the shortest path length among the plurality of coil conductors 60.

As described above, the multilayer coil component 1A according to the modification includes the connection conductors 53 and 54. The connection conductors 53 and 54 are in the element body 2 and connect the coil 6 and the external electrodes 41 and 42 to each other. The connection conductor 53 is continuous with the coil conductor 61 in the same layer as the coil conductor 61, and the connection conductor 54 is continuous with the coil conductor 68 in the same layer as the coil conductor 68. The coil conductors 61 and 68 are endmost coil conductors including an end of the coil 6.

In a configuration in which the connection conductors 53 and 54 are continuous to the coil conductors 61 and 68 in the same layer as the coil conductors 61 and 68, the connection conductors 53 and 54 have a thickness equal to the thickness of the coil conductors 61 and 68. Therefore, since the connection conductors 53 and 54 have a thickness larger than the thickness of the coil conductors 62 and 67, the multilayer coil component 1A further reduces the electric resistance as compared with a configuration in which the connection conductors 53 and 54 have a thickness equal to the thickness of the coil conductors 62 and 67. As a result, the multilayer coil component 1A makes it possible to further improve the Q factor of the multilayer coil component.

The present disclosure has been described in detail based on the embodiments. However, the present disclosure is not limited to the above embodiments. The present disclosure can be variously modified without departing from the scope of the present disclosure. The embodiment and the modification can be appropriately combined.

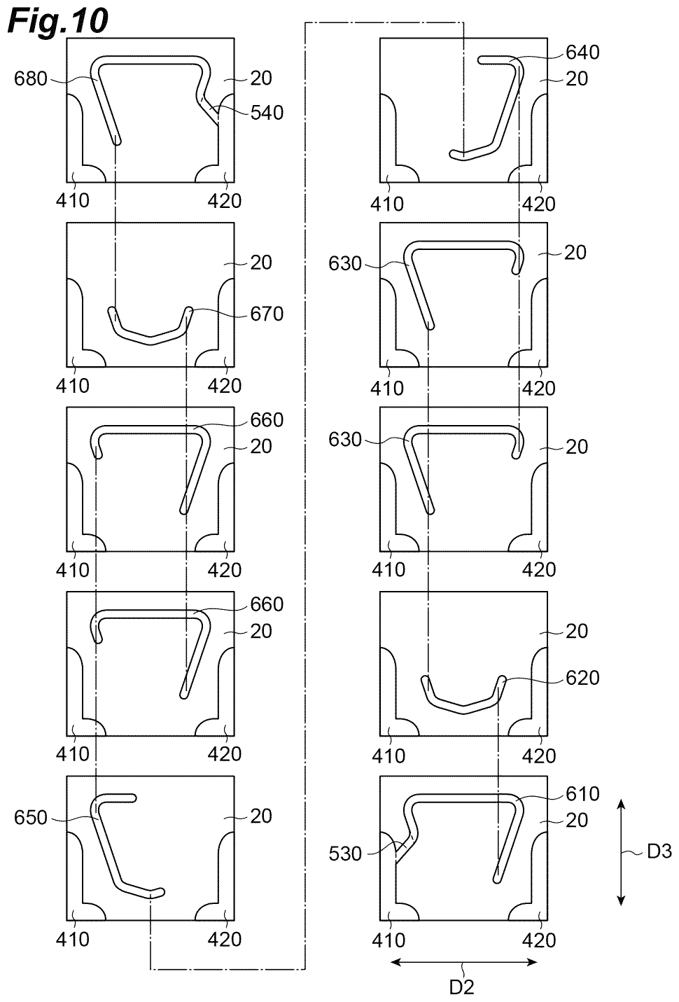

FIG. 10 is an exploded view illustrating a configuration of a multilayer coil component according to another modification different from the modification illustrated in FIGS. 6 to 9. In a multilayer coil component according to another modification illustrated in FIG. 10, the configuration of a plurality of coil conductors 60 is different. In the plurality of coil conductors 60 of the multilayer coil component according to another modification, the coil conductors 61 and 68 include a single coil conductor layer 610 and a single coil conductor layer 680, respectively, and the coil conductors 63 and 66 include a plurality of coil conductor layers 630 and a plurality of coil conductor layers 660, respectively. The number of each of the plurality of coil conductor layers 630 and 660 is “2”.

When viewed from the direction D1, the coil 3 may have a polygonal shape other than a pentagon, or may have a circular shape. The at least one second coil conductor includes a plurality of second coil conductors, and the number of the plurality of second coil conductors may be larger than the number of the at least one first coil conductor.

For example, in the modification illustrated in FIGS. 6 to 9, the plurality of coil conductors 60 may include only the coil conductors 61 and 68 and the coil conductor 62. The coil conductors 61 and 68 are defined as a plurality of second coil conductors, and the coil conductor 62 is defined as at least one first coil conductor. Since the electric resistance of the coil in which the number of the coil conductors 61 and 68 having the thickness larger than the thickness of the coil conductor 62 and having the path length longer than the path length of the coil conductor 62 is larger than the number of the coil conductors 62 is still smaller, the Q factor of the multilayer coil component can be further improved.

What is claimed is:

1. A multilayer coil component comprising:
an element body;
a coil in the element body including a plurality of coil conductors each having a thickness and a path length; and
an external electrode on the element body electrically connected to the coil, wherein
the plurality of coil conductors includes:
at least one first coil conductor; and
at least one second coil conductor having a path length longer than a path length of the at least one first coil conductor and having a thickness larger than a thickness of the at least one first coil conductor.

2. The multilayer coil component according to claim 1, further comprising
a connection conductor in the element body and connecting the coil and the external electrode, wherein
the at least one second coil conductor includes an endmost second coil conductor including an end of the coil, and
the connection conductor is continuous with the endmost second coil conductor in the same layer as the endmost second coil conductor.

3. The multilayer coil component according to claim 1, wherein
the at least one second coil conductor includes a coil conductor having a longest path length among the plurality of coil conductors, and
the at least one first coil conductor includes a coil conductor having a shortest path length among the plurality of coil conductors.

4. The multilayer coil component according to claim 1, wherein ends of a pair of coil conductors adjacent to each other among the plurality of coil conductors overlap each other and are coupled to each other.

5. The multilayer coil component according to claim 1, wherein the at least one second coil conductor has the thickness that is 1.25 times or more than the thickness of the at least one first coil conductor.

6. The multilayer coil component according to claim 5, further comprising
a connection conductor in the element body and connecting the coil and the external electrode, wherein
the at least one second coil conductor includes an endmost second coil conductor including an end of the coil, and
the connection conductor is continuous with the endmost second coil conductor in the same layer as the endmost second coil conductor.

7. The multilayer coil component according to claim 5, wherein
the at least one second coil conductor includes a coil conductor having a longest path length among the plurality of coil conductors, and
the at least one first coil conductor includes a coil conductor having a shortest path length among the plurality of coil conductors.

8. The multilayer coil component according to claim 5, wherein ends of a pair of coil conductors adjacent to each other among the plurality of coil conductors overlap each other and are coupled to each other.

9. The multilayer coil component according to claim 1, wherein
the at least one second coil conductor includes a plurality of second coil conductors, and
the number of the plurality of second coil conductors is larger than the number of the at least one first coil conductor.

10. The multilayer coil component according to claim 9, further comprising
a connection conductor in the element body and connecting the coil and the external electrode, wherein
the at least one second coil conductor includes an endmost second coil conductor including an end of the coil, and
the connection conductor is continuous with the endmost second coil conductor in the same layer as the endmost second coil conductor.

11. The multilayer coil component according to claim 9, wherein
the at least one second coil conductor includes a coil conductor having a longest path length among the plurality of coil conductors, and
the at least one first coil conductor includes a coil conductor having a shortest path length among the plurality of coil conductors.

12. The multilayer coil component according to claim 9, wherein ends of a pair of coil conductors adjacent to each other among the plurality of coil conductors overlap each other and are coupled to each other.
